(19) United States
(12) Patent Application Publication
(10) Pub. No.: US 2025/0145369 A1
(43) Pub. Date: May 8, 2025

(54) HARNESS FOR CONTAINER AND USE OF SAME

(71) Applicant: Arizona Rack Rentals LLC, Tucson, AZ (US)

(72) Inventor: Javier Arrieta, Tucson, AZ (US)

(21) Appl. No.: 18/807,042

(22) Filed: Aug. 16, 2024

Related U.S. Application Data
(60) Provisional application No. 63/596,782, filed on Nov. 7, 2023.

(51) Int. Cl. B65F 1/14

(52) U.S. Cl. CPC B65F 1/1468

(57) ABSTRACT

An apparatus devised to facilitate handling of a barrel-like wheeled container to provide leverage to the user and a method for operation of same.

### CROSS-REFERENCE TO RELATED APPLICATIONS

This US patent application claims priority from and benefit of the U.S. provisional patent application No. 63/596,782 filed on Nov. 7, 2023, the entire disclosure of which is incorporated herein by reference.

### TECHNICAL FIELD

The present invention relates to operation of portable containers—such as trash containers, for example—wheeled containers, and, more particularly, to methodology for easing a movement of such container with the use of a judiciously structured lever apparatus.

### RELATED ART

A typical household rolling garbage/refuse container, when filled, is rather heavy and awkward to roll. The motion required to tip/tilt the container adds stress to the upper body and requires the upper body strength that not everyone possesses, especially the elderly, thereby causing a problem of handling the container to people with limited mobility, the elderly, and/or small/petite people.

The idea of easing the handling of waste containers in not particularly new: a skilled person is aware of multiple versions of a hand truck type apparatus, for example, that provide some mechanical advantage to the user. For example, U.S. Pat. No. 6,182,856 describes a transport vehicle provided with a means for the user to tip the container thereby enabling the user to accommodate various loads.

There remains the need in devising an embodiment of a structure that is specifically designed to reduce the effort of handling heavy waste containers, especially for the aged or those otherwise less able to move trash barrels or similar loads as part of their daily life.

### SUMMARY OF THE INVENTION

Embodiments of the present invention provide an article of manufacture configured as an apparatus facilitating the handling of a large wheeled container, and includes at least a set of rod receptacles (with each receptacle of the set having a hollow extending along an axis) that is configured either (i) to be removably affixed to a back of a waste container or (ii) as a part that is monolithically integrated with the back of the waste container such as to have a corresponding axis of a rod receptacle of the set to extend along the back and transversely to an axle carrying wheels of the waste container. The embodiment additionally includes a handle member that contains a rod (dimensioned to be inserted into the rod receptacle of the set) and a handle member bar (that is substantially transverse to the rod). A given rod receptacle and a given rod are judiciously dimensioned to have the rod secured in the hollow of the rod receptacle. In at least one specific case, the length of the handle member may be adjustable and/or—when the set of rod receptacles is configured to be separable from the container—the set may be structured to include a rigid bar with first and second receptacles at the ends of the rigid bar as well as a harness dimensioned to removably affix the rigid bar to the back of the container while encircling the body of the contained with the harness below an edge of the opening of the container. Alternatively or in addition—and substantially in every implementation when the set of rod receptacles includes multiple rod receptacles and when the handle member includes multiple rods and when the handle member bar has an adjustable length, the rigid bar may be configured to have a variable length. Alternatively or in addition, and substantially in every embodiment of the article, the harness may include an auxiliary harness component configured to form a loop about an axle of a lid of the container. Optionally, and at least in one of various embodiments, when the set includes first and second rods receptacles, the handle member includes respectively corresponding first and second rods, and wherein the handle member bar is configured to connect said first and second rods with one another.

Embodiments additionally provide a method for handling a large wheeled container. The method includes at least a step of inserting a rod into a rod receptacle located at a back of a container that has a first axle with wheels at a bottom of the container to form a lever extending substantially transversely to the first axle, and s step of repositioning the rod to rotate said waste container about the first axle. In at least one implementation of the method, one of the following conditions may be satisfied: (a) the step of inserting the rod into the receptacle includes inserting the rod into the rod receptacle that is configured to be substantially monolithically integrated with the back of the container such that an axis of a hollow of the receptacle is substantially transverse to the first axle; and (b) the method includes a step of removably affixing the receptacle to the back of the container such that the axis of the hollow of the receptacle is substantially transverse to the first axle.

Alternatively or in addition, and substantially in every implementation of the method, the following conditions may be satisfied: (i) the step of inserting includes inserting a first rod into a first receptacle and inserting a second rod into a second receptacle, (ii) each of the first and second receptacles is located at the back of the waste container, (iii) a separation between the first and second receptacles along an axis of rotation of a lid of the container is no larger than a width of the container, and (iv) wherein each of inner structural ribs, which support a second axle employed to rotatably connect a lid of the container with a body of the container, is between first and second planes, the first plane being substantially perpendicular to the second axle and containing a first axis of the first receptacle, the second plane being substantially parallel to the first plane and containing a second axis of the second receptacle. (At least in the latter case, the steps of inserting the first rod into the first receptacle and inserting the second rod into the second receptacle may include inserting the first and second rods of a handle member, the handle member containing a handle bar connecting the first and second rods together and extending between the first and second rods substantially transversely thereto. If this is the case, then, additionally, the handle bar may be configured to have an adjustable length, and the method may additionally include a step of varying the adjustable length of the handle bar to ensure that a separation between the first and second rods is substantially equal to separation between axes of the first and second receptacles.) Alternatively or in addition, and substantially in every implementation of the method when each receptacle present at the back of the container is configured as a tubular element having a hollow therethrough, the hollow of the tubular element may be oriented not parallel to the first axle of the container in operation. Alternatively or in addition, and substantially in every implementation of the method when the receptacle is separable from the container, the method may include encircling a body of the container with a harness containing the receptacle and reversibly securing the harness on the body to substantially prevent the harness from moving with respect to the body and/or (when the receptacle is separable from the container) the method may include a step of positioning a rigid harness bar of the harness at and along the back of the container and, when a lid of the container is connected to the body of the container with the use of a lid axle, securing the harness to the lid axle with the use of a harness loop. Substantially every implementation of the method—when the receptacle is separable from the container and when the receptacle is part of a rigid bar containing another receptacle—may include a step of varying a length of the bar to adjust the separation between receptacles of the bar and removably securing the bar to the back of the container such that axes of the receptacles of the bar are oriented along the back of the container and substantially transversely to the bottom.

### BRIEF DESCRIPTION OF THE DRAWINGS

The invention will be more fully understood by referring to the following Detailed Description of Specific Embodiments in conjunction with the Drawings, of which:

FIGS. 1A, 1B illustrate a typical wheeled container;

FIGS. 2A, 2B, and 2C are different views of a first portion of an embodiment of the article of manufacture structured according to the idea of the invention;

FIG. 2D is a view of a second portion of the embodiment of the article of manufacture;

FIGS. 3A, 3B, 4A, and 4B illustrate the process of attaching the embodiment of the article of manufacture to the container;

FIGS. 5A, 5B, and 6 provide additional views illustrating details of discussed methodology.

Generally, like elements or components in different Drawings may be referenced by like numerals or labels and/or the sizes and relative scales of elements in Drawings may be set to be different from actual ones to appropriately facilitate simplicity, clarity, and understanding of the Drawings. For the same reason, not all elements present in one Drawing may necessarily be shown in another.

### DETAILED DESCRIPTION

A typical household rolling garbage/refuse container, when filled, is rather heavy and awkward to roll. The motion required to tip/tilt the container adds stress to the upper body and requires the upper body strength that not everyone possesses, especially the elderly, thereby causing a problem of handling the container to people with limited mobility, the elderly, and/or small/petite people. Embodiments of the invention solve this problem by devising a complemental construct that—when used with the container—adds more leverage to make the tipping and/or rolling the container easier. An embodiment generally includes a set of rod receptacles (a receiver of sorts, configured to be either removably affixable to the container or monolithic with the container and dimensioned to receive and accept therein a rod-like shaped object, a rod) and a handle member including at least one rod (dimensioned to be inserted into the corresponding rod receptacle) and a handle member bar transverse to such rod. For the purposes of this disclosure and appended claims, the term ‘set’ is defined as including at least one corresponding member of such set. The term ‘rod’ is used in this disclosure as a general term to refer to and defined as a bar, a pipe/tubular element or a similar elongated component regardless of a particular cross-sectional shape of such component.

A combination of the handle member with the receiver is configured to provide leverage (to ease the movement of a barrel-like container with wheels, when affixed to such container) that is greater than leverage available to the user based on the conventional structure of the container (that is, greater than leverage available when the user grasps the frame of the container). The user may engage the embodiment of the discussed-below apparatus using a foot to steady the wheeled container and a hand to operate the handle member. The apparatus reduces bio mechanical stresses on the user.

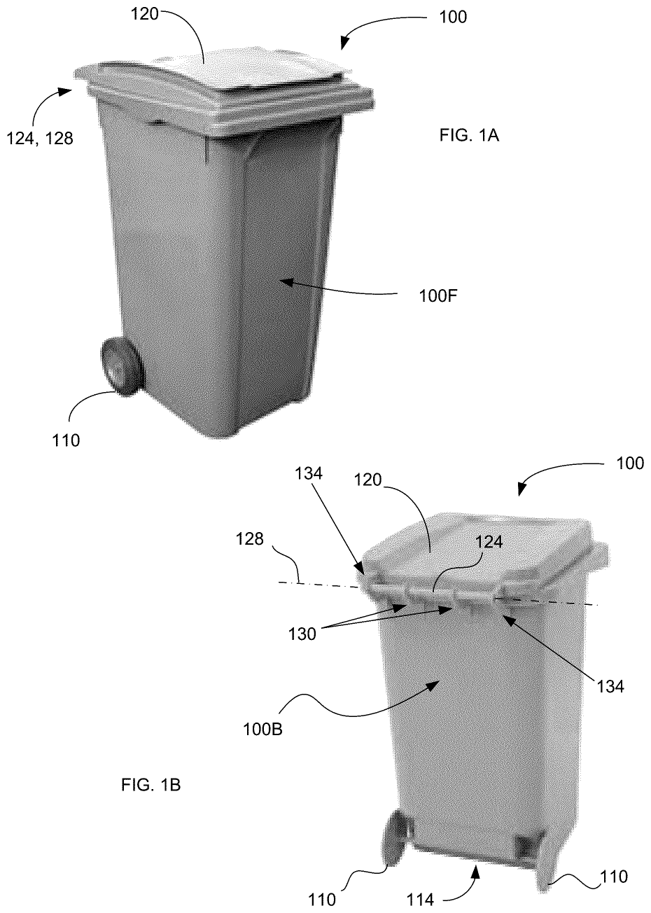

FIGS. 1A and 1B provide schematic illustrations of a waste container 100 (which, as illustrated in this example, is a wheelie type bin container): a first perspective view illustrating a portion of the front of the container 100 is shown in FIG. 1A, while FIG. 1B depicts the container 100 in a second perspective view showing the back 100B of the container 100. The container 100 typically has a body with the front 100F, back 100B, and two sidewalls and the bottom, to which multiple wheels 110 are affixed with the use of the wheel axle 114. Optionally—but quite commonly—the container 100 is covered with a lid 120 that is preferably reversibly rotatable about the corresponding lid axle 124 (defining the corresponding axis of rotation 128). The structural cooperation between the lid axle 124 and the back 100B of the container 100 often employs at least one structural rib (typically configured to be substantially monolithic with the back 100B). When multiple structural ribs are employed, as shown in the specific example of FIG. 1B, the container may be configured to include at least one inner structural rib 130 and at least one outer rib 134. As shown, the embodiment 100 includes two outer structural ribs 134 and two inner structural ribs 130 located in-between the outer structural ribs 134.

An embodiment of the article of manufacture structured according to the idea of the invention (which may interchangeably be referred to herein as a “U-can apparatus”) addresses the persisting need in simplifying the handling of a typical household rolling garbage/refuse container (such as the container 100)—especially when the container 100 is filled and becomes heavy and awkward to roll (often—utilizing the axle 124 as a handle of such container). The motion required to tip and/or tilt the container about the wheel axle 114 when using the axle 124 as a handle adds stress to the upper body and requires more upper body strength—especially from people with limited mobility, those having shoulder issues, and/or small or petite people.

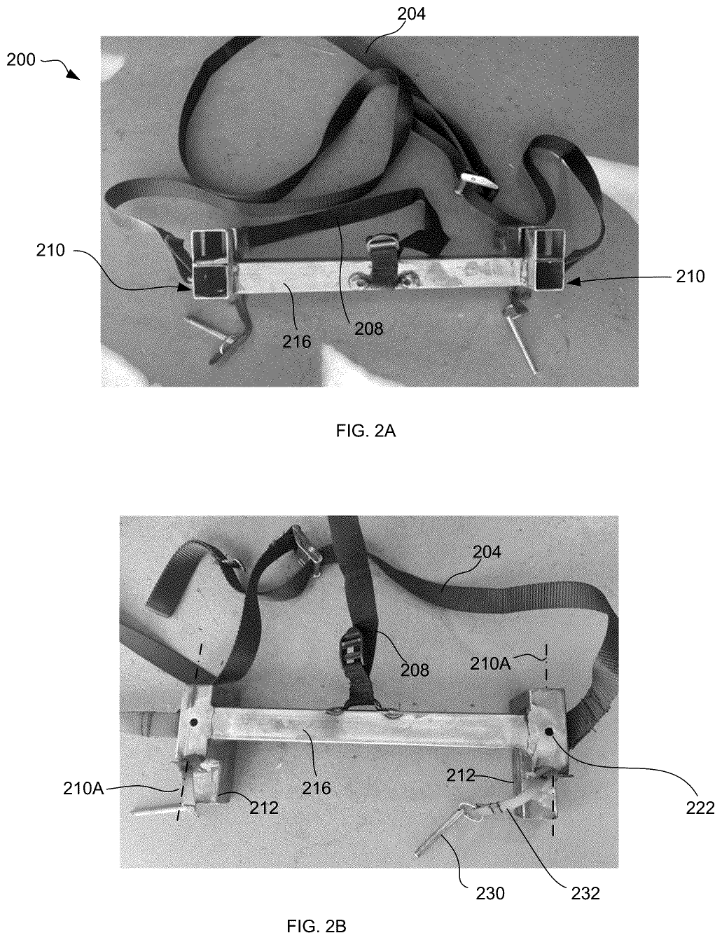

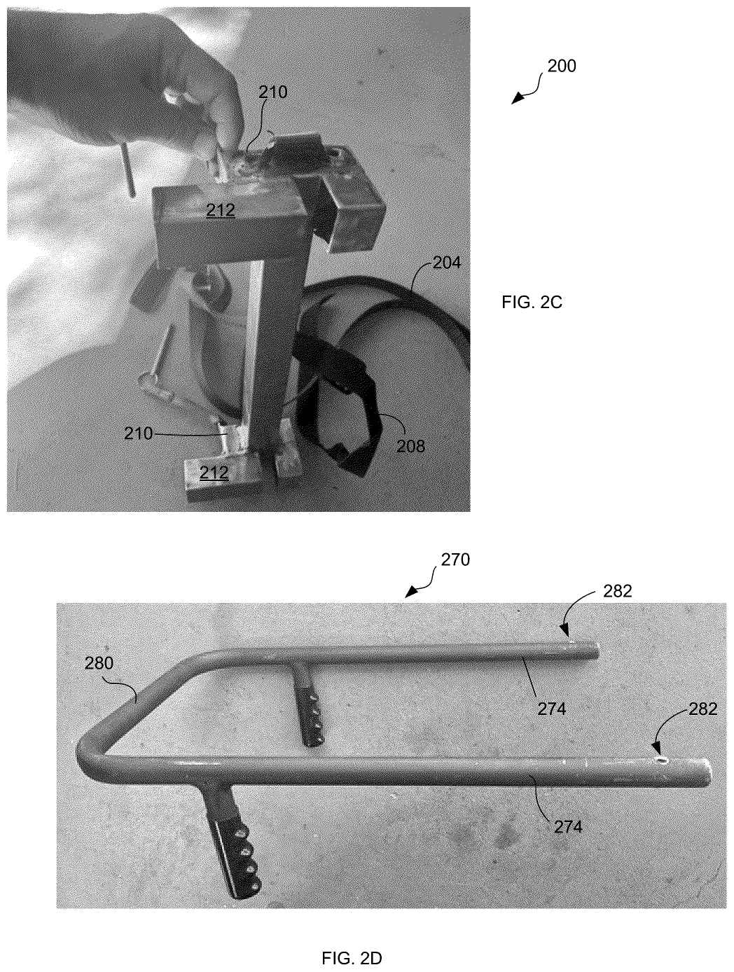

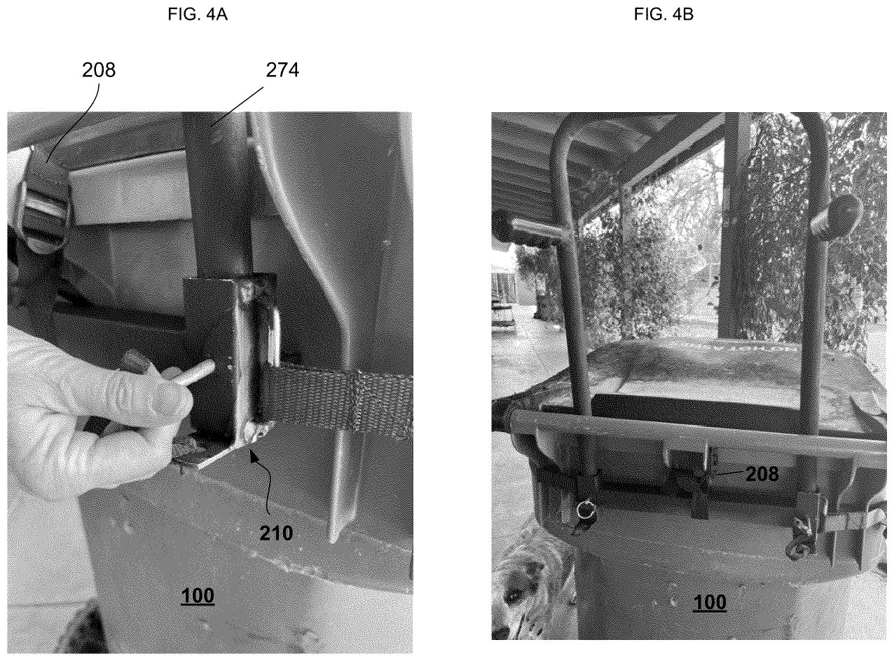

FIGS. 2A, 2B, 2C illustrate, in different views, an embodiment of a first portion 200 of an article of manufacture configured for use with a waste container (for example, a container 100 of a wheelie bin type shown in FIG. 1). FIG. 2D illustrates an embodiment of a second portion 270 of the same article of manufacture, configured as a handle member. The first and second portions or parts of the embodiment are operationally complementary to one another and are dimensioned to be structurally mated with one another (as later on is discussed in reference to FIGS. 4A, 4B). When joined together, the first and second portions 200, 270 form an embodiment of the U-can apparatus structured according to the idea of the invention.

The first portion 200—which, as illustrated in this example, is structured to be removably affixable to the back of the container with the use of a flexible harness 204—includes a set of rod receptacles 210 (as shown, two rod receptacles each having a corresponding hollow extending along a corresponding axis 210A, in this specific non-limiting case—a hollow with a rectangular cross-section).

When more than one rod receptacle is present (as shown in the example 200), the rigid bar 216 may be utilized to connect the rod receptacles that are located—in at least one case—at the ends of the bar 216. Optionally, the length of the rigid bar 216 may be adjustable (for example, telescopically, as a result of configuring such bar from multiple pieces dimensioned accordingly; not shown in FIGS. 2A-2C), thereby providing for freedom of adjusting the separation between the rod receptacles at the ends of the bar 216 and/or of adjusting the length of the bar 216 in reference or with respect to the width of the back 100B of a given container such as container 100.

Preferably, the embodiment of the article of manufacture representing the U-can apparatus is configured to have the set of receptacles 210 be either permanently (in one example—monolithically) or removably integrated with (affixed to) the back 100B of the target container such as to have a corresponding axis of a rod receptacle of the set to extend along the back of the container and transversely to the wheel axle 114. In one implementation, however, the removable affixation of the rod receptacle 210 to the back 100B of the container 100 is arranged with the use of a harness that includes, for example, a strap 204 appropriately dimensioned and equipped to encircle the body of the container (for example, below an edge of the opening of the container, as will be discussed below). Instead of or in addition to a flexible strap, as the skilled artisan will readily appreciate, a combination of rigid mechanical links—that is, an assembly of bodies connected to manage forces and movement—may be employed (not shown in the drawings).

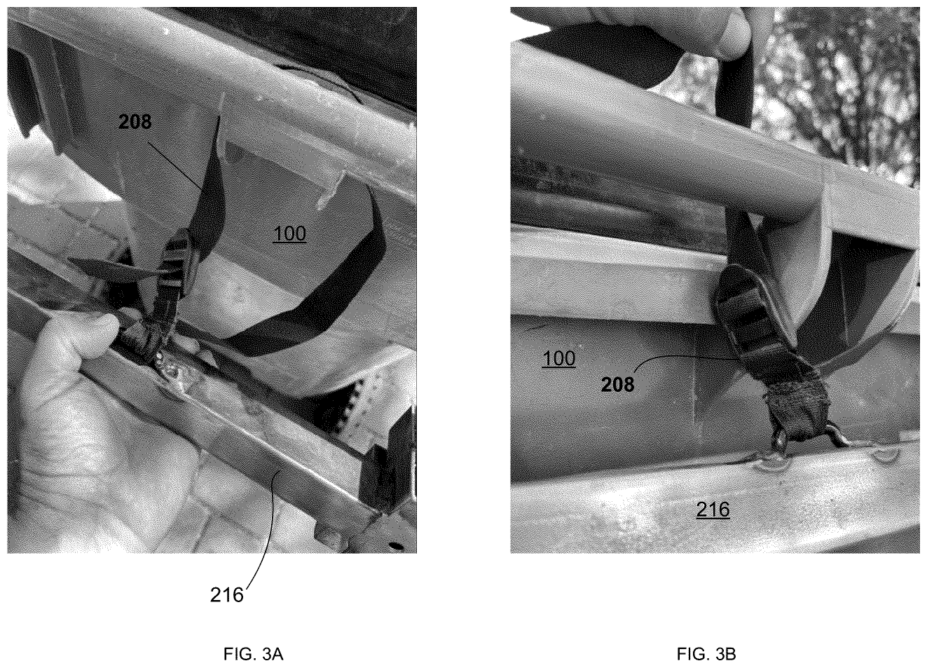

The harness may additionally include an auxiliary harness component 208 (as shown—the strap portion 208) that, when present, is configured to form a loop about the lid axle 124 and/or about at least one structural rib 130, 134 of the container 100. The use of such auxiliary harness component is illustrated in FIGS. 3A, 3B, showing the affixation of the article of manufacture to the container 100.

The second portion 270 of the embodiment of the U-can apparatus—schematically shown in FIG. 2D—includes a set of rods (that is, at least one rod 274) dimensioned to be removably inserted into the corresponding rod receptacle 210 of the set of rod receptacles and a handle member bar 280 that is substantially transverse to the rod 274. When the set of rods 274 includes more than one rod, the handle member bar 280 connects the multiple rods 280 to one another. (The specific cross-sectional dimensions of a given rod receptacle and a corresponding rod are not of particular importance, as long as the rod be dimensioned to fit inside the hollow of the rod receptacle. Optionally, the outer perimeter of the cross-section of the rod may be appropriately dimensionally matched the outer perimeter of the hollow—for example, when the hollow of the rod receptacle is polygonal, the outer surface of the rod may be optionally also made polygonal. The non-limiting example of FIGS. 2A, 2D however illustrates the rectangularly shaped hollow of the rod receptacle 210 and the substantially cylindrical outer surface of the rod 274.) Notably, when multiple rod receptacles are employed in the first portion 200 in combination with the adjustable-length bar 216, and when the respectively-corresponding multiple rods 274 are used in the second portion 270 (in combination with the handle member bar 280), the length of the handle member bar 280 is also preferably made appropriately adjustable (for example, telescopically).

Optionally, a set of spacers 212 may be employed in a given version of the first portion 200 (as shown in the example of FIGS. 2A-2C) that respectively correspond to the rod receptacles 210 that is intended to be used with such given version. Spacers 212, when present, may be used to define proper fit and/or separation between the set of rod receptacles and the body of the container for ease of installation and/or removal of the handle member.

FIGS. 3A, 3B illustrate the attachment of the embodiment 200 to the back of the container 100—specifically, the process of utilizing the strap portion 208 equipped with the buckle to encircle at least one of the inner structural ribs 130 (cooperating the lid 20 with the back 100B of the container) and forming the loop around the encircled inner rib(s) while tightening the loop to secure the mid-section of the bar 216 to the container 100.

The skilled person will readily appreciate in reference to FIGS. 2A through 2D and to FIGS. 4A, 4B discussed below—that an embodiment of the invention may be judiciously configured such that a given rod 274 of the second portion 270, once inserted into the corresponding rod receptacle 210, can be reversibly secured in a hollow of the rod receptacle 210. Such operation may be accomplished, for example, by utilizing a through hole 22 formed in a wall of the rod receptacle and/or the corresponding hole 282 formed in the rod 274 and employing these holes for limiting the motion of a position securing device, generally. In one case, for example, as shown in FIG. 2B, these holes may be spatially aligned and used to pass a corresponding locking pin 230 therethrough (the pin is shown in the example of FIG. 2B attached to the first portion 210 with the use of a lanyard 232). In another example, a judiciously structured button and/or a spring-loaded apparatus (not shown) as recognized by a skilled person may be used for the same purpose.

Understandably, the holes 232, 282 may be structured as openings formed throughout, respectively, the rod receptacle 210 and the rod 274. FIG. 4B illustrates the situation when the combination of the first portion 200 and the second portion 270 has been already affixed to the container 100 (with the strap portion seen tightened around one inner structural rib of the container). As shown in the example of FIG. 4B, the separation between the two rod receptacles at the ends of the bar 216 (along the axis of rotation 128 of the lid of the container 100) is chosen to be no larger than the width of the back of the container and/or sufficiently large to ensure that at least one inner structural rib 130 of the container (around which the auxiliary harness component 208 is forming a loop) is positioned between the rod receptacles.

The methodology of the use of an embodiment of the invention generally includes, therefore, inserting a rod into a rod receptacle located at a back of a waste container (which container has a first axle with wheels at a bottom of the container) to form a lever extending substantially transversely to the first axle, and repositioning the rod to rotate said waste container about the first axle. When the rod receptacle is spatially separable from the container, the method may additionally include a step of removably affixing the rod receptacle to the back of the container such that the axis of the hollow of the rod receptacle is substantially transverse to the first axle.

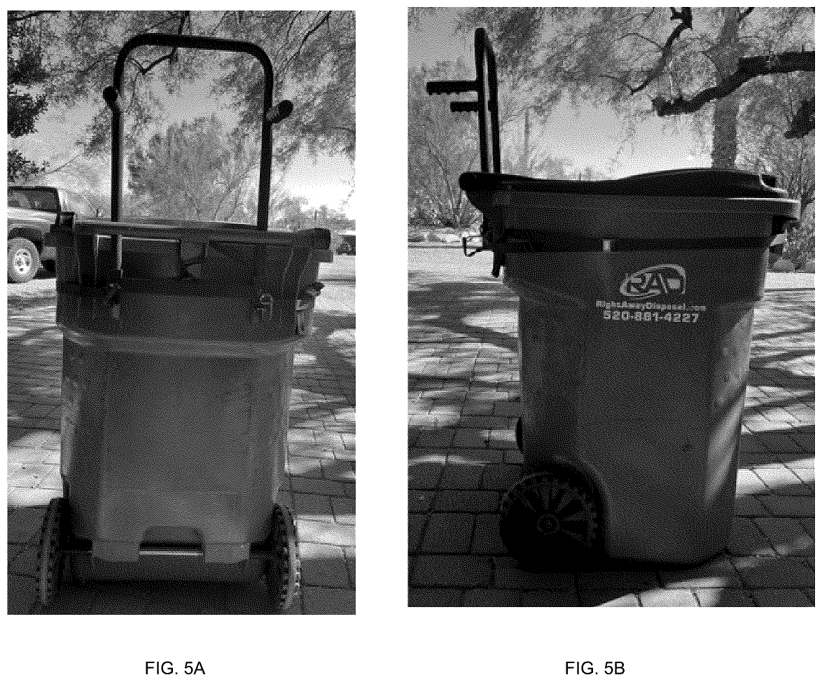

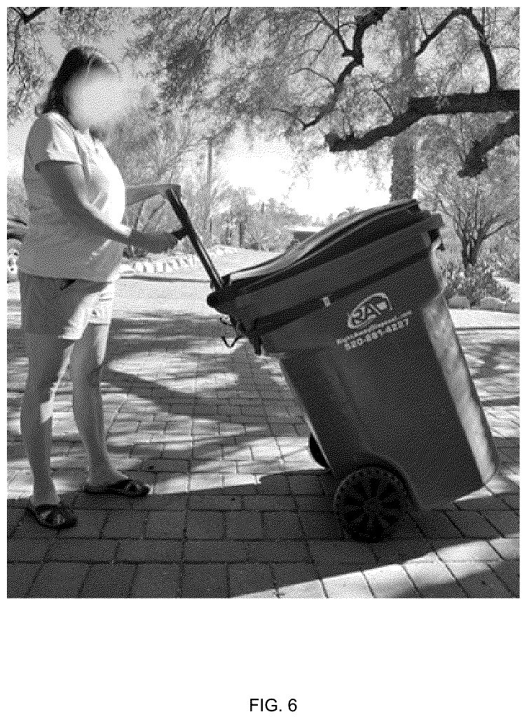

FIGS. 5A, and 5B provide different views of the wheelie-bin type container 100 equipped with an embodiment of the invention, while FIG. 6 illustrates the ease of handling of the so-equipped container by a user.

While the discussion on one specific embodiment—the one constructed to be removably affixable to the target container—was presented above, the skilled person will readily appreciate that a rod receptacle can be configured to be substantially monolithic with the container (which may require fabricating the container such as container 100 with a rod receptacle is molded at the back surface thereof). Materials involved in fabrication of an embodiment of the invention include, for example, plastic(s), fabric(s), and metal(s).

References throughout this specification to “one embodiment,” “an embodiment,” “a related embodiment,” or similar language mean that a particular feature, structure, or characteristic described in connection with the referred to “embodiment” is included in at least one embodiment of the present invention. Thus, appearances of the phrases “in one embodiment,” “in an embodiment,” and similar language throughout this specification may, but do not necessarily, all refer to the same embodiment. It is to be understood that no portion of disclosure, taken on its own and in possible connection with a figure, is intended to provide a complete description of all features of the invention.

Within this specification, embodiments have been described in a way that enables a clear and concise specification to bet written, but it is intended and will be appreciated that embodiments may be variously combined or separated without parting from the scope of the invention. In particular, it will be appreciated that all features described herein at applicable to all aspects of the invention.

For the purposes of this disclosure and the appended claims, the use of the terms “substantially”, “approximately”, “about” and similar terms in reference to a descriptor of a value, element, property or characteristic at hand is intended to emphasize that the value, element, property, or characteristic referred to, while not necessarily being exactly as stated, would nevertheless be considered, for practical purposes, as stated by a person of skill in the art. These terms, as applied to a specified characteristic or quality descriptor means “mostly”, “mainly”, “considerably”, “by and large”, “essentially”, “to great or significant extent”, “largely but not necessarily wholly the same” such as to reasonably denote language of approximation and describe the specified characteristic or descriptor so that its scope would be understood by a person of ordinary skill in the art. In one specific case, the terms “approximately”, “substantially”, and “about”, when used in reference to a numerical value, represent a range of plus or minus 20% with respect to the specified value, more preferably plus or minus 10%, even more preferably plus or minus 5%, most preferably plus or minus 2% with respect to the specified value. As a non-limiting example, two values being “substantially equal” to one another implies that the difference between the two values may be within the range of +/−20% of the value itself, preferably within the +/−10% range of the value itself, more preferably within the range of +/−5% of the value itself, and even more preferably within the range of +/−2% or less of the value itself.

The use of these terms in describing a chosen characteristic or concept neither implies nor provides any basis for indefiniteness and for adding a numerical limitation to the specified characteristic or descriptor. As understood by a skilled artisan, the practical deviation of the exact value or characteristic of such value, element, or property from that stated falls and may vary within a numerical range defined by an experimental measurement error that is typical when using a measurement method accepted in the art for such purposes.

The term “and/or”, as used in connection with a recitation involving an element A and an element B, is defined to have the same meaning as “as least one of A and B”.

Disclosed aspects of embodiment(s), or portions of these aspects, may be combined in ways not listed above. Accordingly, the invention should not be viewed as being limited to the disclosed embodiment(s).

What is claimed is:

1. An article of manufacture comprising:
a set of rod receptacles, a rod receptacle of the set having a hollow extending along an axis, the set being configured either to be removably affixed to a back of a waste container or as a part monolithically integrated with the back of the waste container such as to have a corresponding axis of the rod receptacle of the set to extend along the back and transversely to an axle carrying wheels of the waste container; and
a handle member including a rod dimensioned to be inserted into the rod receptacle of the set, and a handle member bar that is substantially transverse to the rod,
wherein a given rod receptacle is configured to have the rod secured in the hollow.

2. An article of manufacture according to claim 1, wherein, when the set includes first and second rods receptacles, the handle member includes respectively corresponding first and second rods, and wherein the handle member bar is configured to connect said first and second rods with one another.

3. An article of manufacture according to claim 2, wherein the handle member bar has an adjustable length.

4. An article of manufacture according to claim 3, wherein, when the set of rod receptacles is configured to be separable from the waste container, the set is structured to include a rigid bar having first and second receptacles at ends thereof, and a harness dimensioned to removably affix the rigid bar to the back of the waste container while encircling a body of the waste container with said harness below an edge of the opening of the waste container.

5. An article of manufacture according to claim 4, wherein the harness includes an auxiliary harness component configured to form a loop about an axle of a lid of the container.

6. An article of manufacture according to claim 1, wherein, when the set of rod receptacles is configured to be separable from the waste container, the set is structured to include a rigid bar having first and second receptacles at ends thereof, and a harness dimensioned to removably affix the rigid bar to the back of the waste container while encircling a body of the waste container with said harness below an edge of the opening of the waste container.

7. An article of manufacture according to claim 6, wherein, when the set of rod receptacles includes multiple rod receptacles and when the handle member includes multiple rods and when the handle member bar has an adjustable length, the rigid bar is configured to have a variable length.

8. An article of manufacture according to claim 6, wherein the harness includes an auxiliary harness component configured to form a loop about an axle of a lid of the container.

9. An article of manufacture according to claim 1,
wherein the set includes first and second receptacles,
wherein that article is dimensioned such that, when cooperated with the back of the waste container:
(i) a separation between the first and second receptacles along an axis of rotation of a lid of the container is no larger than a width of the container, and
(ii) wherein, when the waste container includes inner structural ribs, which support a second axle employed to rotatably connect a lid of the container with a body of the container, each of such inner structural ribs is between first and second planes, the first plane being substantially perpendicular to the second axle and containing a first axis of the first receptacle, the second plane being substantially parallel to the first plane and containing a second axis of the second receptacle.

10. A method comprising:
using the article of manufacture according to claim 1:
inserting the rod of the handle member into the rod receptacle of the set of the rod receptacles located at a back of a waste container that has a first axle with wheels at a bottom thereof to form a lever extending substantially transversely to the first axle;
and
repositioning the rod to rotate said waste container about the first axle.

11. A method according to claim 10, wherein:
(11A) the inserting includes inserting the rod into the rod receptacle that is configured to be substantially monolithically integrated with the back of the waste container such that the axis of the hollow of the receptacle is substantially transverse to the first axle; or
(11B) the method comprises removably affixing the rod receptacle to the back of the waste container such that the axis of the hollow of the receptacle is substantially transverse to the first axle.

12. A method according to claim 10,
wherein said waste container is a wheelie bin type container; and/or
further comprising: pushing a handle affixed to said rod to roll the waste container.

13. A method according to claim 10,
wherein said inserting includes inserting a first rod into a first receptacle of the set and inserting a second rod into a second receptacle of the set,
wherein each of the first and second receptacles is located at the back of the waste container,
wherein a separation between the first and second receptacles along an axis of rotation of a lid of the container is no larger than a width of the container, and
wherein each of inner structural ribs, which support a second axle employed to rotatably connect a lid of the container with a body of the container, is between first and second planes, the first plane being substantially perpendicular to the second axle and containing a first axis of the first receptacle, the second plane being substantially parallel to the first plane and containing a second axis of the second receptacle.

14. A method according to claim 13, wherein said inserting the first rod into the first receptacle and inserting the second rod into the second receptacle includes inserting the first and second rods of a handle member, the handle member including a handle bar connecting the first and second rods together and extending between the first and second rods substantially transversely thereto.

15. A method according to claim 14, wherein the handle bar is configured to have an adjustable length, and further comprising varying said adjustable length to ensure that a separation between the first and second rods is substantially equal to separation between axes of the first and second receptacles.

16. A method according to claim 10, wherein each receptacle of the set present at the back of the container is configured as a tubular element having a hollow therethrough, the hollow oriented not parallel to the first axle.

17. A method according to claim 10, wherein, when a rod receptacle of the set is configured to be separable from the waste container, the method comprises encircling a body of the waste container with a harness containing said receptacle and reversibly securing the harness on the body to substantially prevent the harness from moving with respect to the body.

18. A method according to claim 10, wherein, when a rod receptacle of the set is configured to be separable from the container, the method comprises positioning a rigid harness bar of the harness at and along the back of the container and, when a lid of the container is connected to the body of the container with the use of a lid axle, securing the harness to the lid axle with the use of a harness loop.

19. A method according to claim 10, wherein, when the rod receptacle is configured to be separable from the container and when the receptacle is part of a rigid bar containing another receptacle, the method comprises varying a length of the bar to adjust the separation between receptacles of the bar and removably securing the bar to the back of the container such that axes of the receptacles of the bar are oriented along the back of the container and substantially transversely to the bottom.
